(19) United States
(12) Patent Application Publication
(10) Pub. No.: US 2021/0358153 A1
(43) Pub. Date: Nov. 18, 2021

(54) DETECTION METHODS, DETECTION APPARATUSES, ELECTRONIC DEVICES AND STORAGE MEDIA

(71) Applicant: SHENZHEN SENSETIME TECHNOLOGY CO., LTD., SHENZHEN (CN)

(72) Inventors: Yingjie CAI, Shenzhen (CN); Xingyu ZENG, Shenzhen (CN); Shinan LIU, Shenzhen (CN); Junjie YAN, Shenzhen (CN); Xiaogang WANG, Shenzhen (CN)

(21) Appl. No.: 17/388,912

(22) Filed: Jul. 29, 2021

Related U.S. Application Data
(63) Continuation of application No. PCT/CN2021/072750, filed on Jan. 19, 2021.

(30) Foreign Application Priority Data
Jan. 19, 2020 (CN) 202010060288.7

(51) Int. Cl. G06T 7/543; G06T 15/20; G06K 9/00; G06K 9/62

(52) U.S. Cl. CPC G06T 7/543; G06T 15/20; G06K 9/0063; G06K 9/00201; G06K 9/6218; G06K 2209/21; G06T 2207/20081; G06T 2210/12; G06K 9/00791; G06K 9/00671; G06T 2207/20084

(57) ABSTRACT

Example detecting methods and apparatus are described. One example method includes: acquiring a two-dimensional image; and constructing, for each of one or more objects under detection in the two-dimensional image, a structured polygon corresponding to the object under detection based on the acquired two-dimensional image, wherein for each object under detection, a structured polygon corresponding to the object represents projection of a three-dimensional bounding box corresponding to the object in the two-dimensional image; for each object under detection, calculating depth information of vertices in the structured polygon based on height information of the object and height information of vertical sides of the structured polygon corresponding to the object; and determining three-dimensional spatial information of the object under detection based on the depth information of the vertices in the structured polygon and two-dimensional coordinate information of the vertices of the structured polygon in the two-dimensional image.

### CROSS-REFERENCE TO RELATED APPLICATIONS

The present application is a continuation of International Application No. PCT/CN2021/072750, filed on Jan. 19, 2021, which claims priority to Chinese patent application No. 202010060288.7, titled “DETECTION METHODS, DETECTION APPARATUSES, ELECTRONIC DEVICES AND STORAGE MEDIA”, filed on Jan. 19, 2020, all of which is incorporated herein by reference in their entirety.

### TECHNICAL FIELD

The present disclosure relates to the field of image processing technology, and in particular to a detection method, a detection apparatus, an electronic device for detecting, and a storage medium for detecting.

### BACKGROUND

In the field of computer vision, three-division (3D) target detection is one of the most basic tasks. The 3D target detection can be applied to scenarios such as automatic driving and robot performing tasks.

### SUMMARY

In view of this, the present disclosure provides at least a detection method, a detection apparatus, an electronic device for detecting, and a storage medium for detecting.

In a first aspect, the present disclosure provides a detection method, including: acquiring a two-dimensional image; constructing, for each of one or more objects under detection in the two-dimensional image, a structured polygon corresponding to the object under detection based on the acquired two-dimensional image, where for each of the one or more objects under detection, a structured polygon corresponding to the object under detection represents projection of a three-dimensional bounding box corresponding to the object under detection in the two-dimensional image; for each of the one or more objects under detection, calculating depth information of vertices in the structured polygon based on height information of the object under detection and height information of vertical sides of the structured polygon corresponding to the object under detection; and determining three-dimensional spatial information of the object under detection based on the depth information of the vertices in the structured polygon and two-dimensional coordinate information of the vertices of the structured polygon in the two-dimensional image, where the three-dimensional spatial information of the object under detection is related to the three-dimensional bounding box corresponding to the object under detection.

Since the constructed structured polygon is the projection of the three-dimensional bounding box corresponding to the object under detection in the two-dimensional image, the constructed structured polygon can better characterize three-dimensional features of the object under detection. This makes the depth information predicted based on the structured polygon has a higher accuracy than the depth information directly predicted based on features of the two-dimensional image, which in turn makes the obtained three-dimensional spatial information of the object under detection more accurate, which improves the accuracy of 3D detection results.

In a second aspect, the present disclosure provides a detection apparatus, including: an image acquisition unit configured to acquire a two-dimensional image; a structured polygon construction unit configured to construct, for each of one or more objects under detection in the two-dimensional image, a structured polygon corresponding to the object under detection based on the acquired two-dimensional image, where for each of the one or more objects under detection, a structured polygon corresponding to the object under detection represents projection of a three-dimensional bounding box corresponding to the object under detection in the two-dimensional image; a depth information determination unit configured to, for each of the one or more objects under detection, calculate depth information of vertices in the structured polygon based on height information of the object under detection and height information of vertical sides of the structured polygon corresponding to the object under detection; and a three-dimensional spatial information determination unit configured to determine three-dimensional spatial information of the object under detection based on the depth information of the vertices in the structured polygon and two-dimensional coordinate information of the vertices of the structured polygon in the two-dimensional image, where the three-dimensional spatial information of the object under detection is related to the three-dimensional bounding box corresponding to the object under detection.

In a third aspect, the present disclosure provides an electronic device including: a processor; a memory for storing machine-readable instructions executable by the processor; and; and a bus. When the electronic device is running, the processor and the memory communicate with each other via the bus, when the machine-readable instructions are executed by the processor, the steps of the detection method described in the first aspect or any of the implementations are executed.

In a fourth aspect, the present disclosure provides a computer-readable storage medium, a computer program is stored on the computer-readable storage medium, and the computer program is executed by a processor to perform the steps of the detection method described in the first aspect or any of the implementations.

In order to make the above-mentioned objectives, features and advantages of the present disclosure more apparent and understandable, the following is a detailed description of preferred embodiments in conjunction with accompanying drawings.

### BRIEF DESCRIPTION OF THE DRAWINGS

In order to more clearly describe technical solutions of the embodiments of the present disclosure, the following will briefly introduce the drawings referred in the embodiments, and the drawings here are incorporated into the specification and constitute a part of the specification. These drawings show embodiments in accordance with the present disclosure, and together with the description are used to illustrate the technical solutions of the present disclosure. It should be understood that the following drawings only show certain embodiments of the present disclosure, and therefore should not be regarded as limiting the scope. For those of ordinary skill in the art, other related drawings can be obtained based on these drawings without creative effort.

FIG. 1 is a schematic flowchart illustrating a detection method according to an embodiment of the present disclosure;

FIG. 2a is a schematic structural diagram illustrating a structured polygon corresponding to an object under detection in a detection method according to an embodiment of the present disclosure;

FIG. 2b is a schematic structural diagram illustrating a three-dimensional bounding box corresponding to the object under detection in a detection method according to an embodiment of the present disclosure, and projection of the three-dimensional bounding box in a two-dimensional image is the structured polygon in FIG. 2a;

FIG. 3 is a schematic flowchart illustrating a method for constructing a structured polygon corresponding to an object under detection in a detection method according to an embodiment of the present disclosure;

FIG. 4 is a schematic flowchart illustrating a method for determining attribute information of a structured polygon corresponding to an object under detection in a detection method according to an embodiment of the present disclosure;

FIG. 5 is a schematic flowchart illustrating a method for performing feature extraction on a target image corresponding to an object under detection in a detection method according to an embodiment of the present disclosure;

FIG. 6 is a schematic structural diagram illustrating a feature extraction model in a detection method according to an embodiment of the present disclosure;

FIG. 7 is a schematic structural diagram illustrating a corresponding relationship between a structured polygon corresponding to an object under detection determined based on a two-dimensional image and a three-dimensional bounding box corresponding to the object under detection in a detection method according to an embodiment of the present disclosure;

FIG. 8 is a top view of an image under detection in a detection method according to an embodiment of the present disclosure;

FIG. 9 is a schematic flowchart illustrating a method for obtaining adjusted three-dimensional spatial information of an object under detection in a detection method according to an embodiment of the present disclosure;

FIG. 10 is a schematic structural diagram illustrating an image detection model in a detection method according to an embodiment of the present disclosure;

FIG. 11 is a schematic structural diagram illustrating a detection apparatus according to an embodiment of the present disclosure; and

FIG. 12 shows a schematic structural diagram illustrating an electronic device according to an embodiment of the present disclosure.

### DETAILED DESCRIPTION OF THE EMBODIMENTS

In order to more clearly describe objectives, the technical solutions and advantages of the embodiments of the present disclosure, the following will clearly and fully describe the technical solutions in the embodiments of the present disclosure with reference to the drawings in the embodiments of the present disclosure. Apparently, the described embodiments are only a part of the embodiments of the present disclosure, rather than all the embodiments. The components of the embodiments of the present disclosure generally described and illustrated in the drawings herein can be arranged and designed in a variety of different configurations. Therefore, the following detailed description of the embodiments of the present disclosure provided in the accompanying drawings is not intended to limit the scope of the claimed present disclosure, but merely represents selected embodiments of the present disclosure. Based on the embodiments of the present disclosure, all other embodiments obtained by those skilled in the art without creative work shall fall within the protection scope of the present disclosure.

In order to realize safe driving of unmanned vehicles and avoid collisions between a vehicle and surrounding objects, it is expected to detect surrounding objects during a driving of a vehicle, and determine locations of the surrounding objects, driving direction of the vehicle and other spatial information. That is, 3D target detection is desirable.

In scenarios such as automatic driving and robot transportation, generally, two-dimensional images are captured by camera devices, and a target object in front of a vehicle or a robot is recognized from the two-dimensional images, such as recognizing an obstacle ahead, so that the vehicle or the robot can avoid the obstacle. Since from a two-dimensional image, only a size of a target object in a planar dimension can be recognized, it is impossible to accurately learn about three-dimensional spatial information of the target object in the real world. As a result, when performing tasks such as automatic driving and robot transportation based on the recognition results, some dangerous situations may occur, such as crashes, hitting obstacles, or the like. In order to learn about three-dimensional spatial information of a target object in the real world, embodiments of the present disclosure provide a detection method, which obtains depth information and a structured polygon corresponding to an object under detection based on a two-dimensional image, so as to realize 3D target detection.

According to the detection method provided by the embodiments of the present disclosure, a structured polygon is constructed for each object under detection involved in an acquired two-dimensional image. Since a constructed structured polygon is projection of a three-dimensional bounding box corresponding to an object under detection in the two-dimensional image, the constructed structured polygon can better represent three-dimensional features of the object under detection. In addition, according to the detection method provided by the embodiments of the present disclosure, depth information of vertices in the structured polygon is calculated based on height information of the object under detection and height information of vertical sides of the structured polygon corresponding to the object under detection. Such depth information predicted based on the structured polygon has higher accuracy than depth information predicted directly based on features of the two-dimensional image. Furthermore, in a case that three-dimensional spatial information of the object under detection is determined based on the depth information of the vertices in the structured polygon and two-dimensional coordinate information of the vertices of the structured polygon in the two-dimensional image, the accuracy of the obtained three-dimensional spatial information can be relatively high, and thus the accuracy of the 3D target detection result can be improved.

In order to facilitate understanding of the embodiments of the present disclosure, a detection method disclosed in the embodiments of the present disclosure is first described in detail.

The detection method provided by the embodiments of the present disclosure can be applied to a server or a smart terminal device with a central processing unit. The server can be a local server or a cloud server, or the like. The smart terminal device can be a smart phone, a tablet computer, a personal digital assistant (Personal Digital Assistant, PDA), or the like, which is not limited in the present disclosure.

The detection method provided by the present disclosure can be applied to any scenario that needs to perceive an object under detection. For example, the detection method can be applied to an automatic driving scenario, or it can be applied to a scenario in which robot performs tasks. For example, when the detection method is applied to an automatic driving scenario, a camera device installed on a vehicle acquires a two-dimensional image while the vehicle is driving, and sends the acquired two-dimensional image to a server for 3D target detection, or sends the acquired two-dimensional image to a smart terminal device. The server or the smart terminal device processes the two-dimensional image with the detection method provided by the embodiments of the present disclosure, and determines three-dimensional spatial information of each object under detection involved in the two-dimensional image.

Referring to FIG. 1, which is a schematic flowchart illustrating a detection method according to an embodiment of the present disclosure, and taking that the detection method is applied to a server as an example for description. The detection method includes the following steps S101-S104.

In S101, acquiring a two-dimensional image. The two-dimensional image relates to one or more objects under detection.

In S102, constructing, for each of the one or more objects under detection in the two-dimensional image, a structured polygon corresponding to the object under detection based on the acquired two-dimensional image. A structured polygon corresponding to an object under detection represents projection of a three-dimensional bounding box corresponding to the object under detection in the two-dimensional image.

In S103, for each of the one or more objects under detection, calculating depth information of vertices in the structured polygon based on height information of the object under detection and height information of vertical sides of the structured polygon corresponding to the object under detection.

In S104, determining three-dimensional spatial information of the object under detection based on the calculated depth information of the vertices in the structured polygon and two-dimensional coordinate information of the vertices of the structured polygon in the two-dimensional image, the three-dimensional spatial information of the object under detection is related to the three-dimensional bounding box corresponding to the object under detection.

S101˜S104 are respectively described below.

Regarding S101: in the embodiments of the present disclosure, the server or the smart terminal device can acquire a two-dimensional image captured by a camera device in real time, or can acquire a two-dimensional image within a preset capturing period from a storage module for storing two-dimensional images. Here, the two-dimensional image can be a red-green-blue (RGB) image acquired by a camera device.

In specific implementation, for scenarios such as automatic driving or robot transportation, a two-dimensional image corresponding to a current position of a vehicle or a robot can be acquired in real time during the driving of the vehicle or the robot transportation, and the acquired two-dimensional image can be processed.

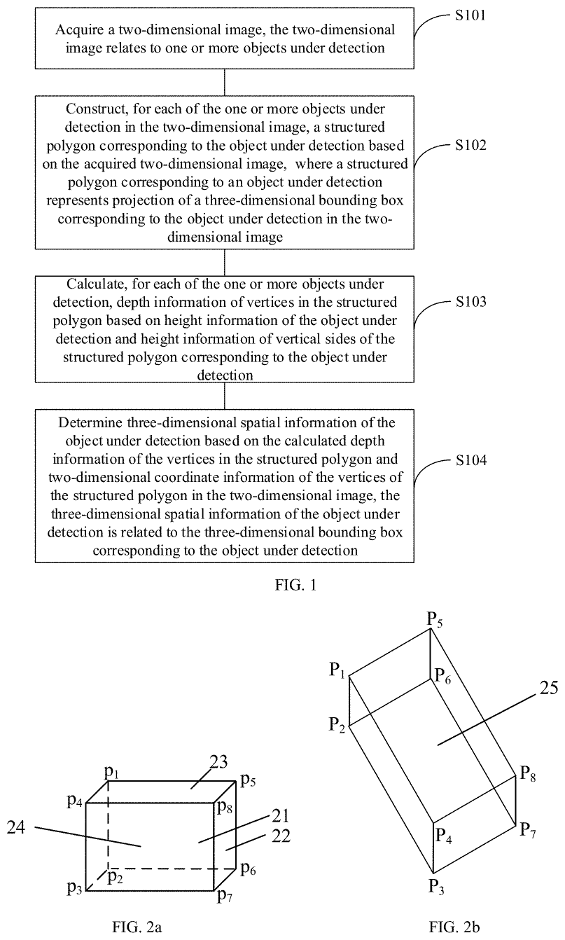

Regarding S102: in the embodiments of the present disclosure, referring to the schematic structural diagrams in FIG. 2a and FIG. 2b, which illustrate a structured polygon corresponding to an object under detection and a three-dimensional bounding box corresponding to the object under detection in the detection method. Here, the structured polygon 24 corresponding to the object under detection is projection of the three-dimensional bounding box 25 of a rectangular parallelepiped structure in a two-dimensional image. In specific implementation, if the two-dimensional image includes a plurality of objects under detection, a corresponding structured polygon is constructed for each object under detection. In specific implementation, the object under detection can be any object that needs to be detected during the driving of the vehicle. For example, the object under detection can be a vehicle, an animal, a pedestrian, or the like.

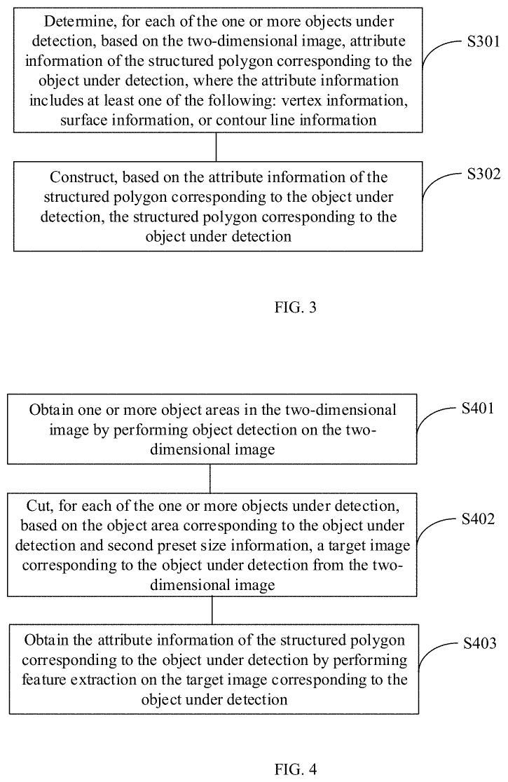

In a possible implementation, referring to FIG. 3, based on the acquired two-dimensional image, for each of the one or more objects under detection in the two-dimensional image, constructing a structured polygon corresponding to the object under detection includes the following steps S301-S302.

In S301, for each of the one or more objects under detection, based on the two-dimensional image, determining attribute information of the structured polygon corresponding to the object under detection. The attribute information includes at least one of the following: vertex information, surface information, or contour line information.

In S302, based on the attribute information of the structured polygon corresponding to the object under detection, constructing the structured polygon corresponding to the object under detection.

Exemplarily, when the attribute information includes the vertex information, for each object under detection, information of a plurality of vertices of the structured polygon corresponding to the object under detection can be determined based on the two-dimensional image, and from the obtained information of the plurality of vertices, a structured polygon corresponding to the object under detection can be constructed. Taking FIG. 2a as an example, the information of the plurality of vertices can be coordinate information of eight vertices of the structured polygon 24, that is, the coordinate information of each vertex of the vertices p₁, p₂, p₃, p₄, p₅, p₆, p₇, and p₈. Alternatively, the information of the plurality of vertices can also be coordinate information of a part of vertices of the structured polygon 24, and a structured polygon can be uniquely determined based on the coordinate information of this part of vertices. For example, the coordinate information of a part of vertices can be coordinate information of each of the vertices p₃, p₄, p₅, p₆, p₇, and p₈, or the coordinate information of a part of vertices can also be coordinate information of each of the vertices p₃, p₆, p₇, and p₈. Which part of the vertices is specifically used to uniquely determine a structured polygon can be determined according to actual conditions, which is not limited in the embodiments of the present disclosure.

Exemplarily, when the attribute information includes the surface information, for each object under detection, plane information of a plurality of surfaces of the structured polygon corresponding to the object under detection can be determined based on the two-dimensional image, and a structured polygon corresponding to the object under detection can be constructed from the obtained plane information of the plurality of surfaces. Taking FIG. 2a as an example for description, the plane information of the plurality of surfaces can be shapes and positions of six surfaces of the structured polygon 24. Alternatively, the plane information of the plurality of surfaces can also be the shapes and positions of a part of the surfaces of the structured polygon 24, and a structured polygon can be uniquely determined based on the shapes and positions of this part of the surfaces. For example, a part of the surfaces can be a first plane 21, a second plane 22, and a third plane 23, or a part of the surfaces can also be the first plane 21 and the second plane 22. Which part of the planes is specifically used to uniquely determine a structured polygon can be determined according to actual conditions, which is not specifically limited in the embodiments of the present disclosure.

Exemplarily, when the attribute information includes the contour line information, for each object under detection, information of a plurality of contour lines of the structured polygon corresponding to the object under detection can be determined based on the two-dimensional image, and the obtained information of the plurality of contour lines can be used to construct the structured polygon corresponding to the object under detection. Taking FIG. 2a as an example for description, information of the plurality of contour lines can be positions and lengths of 12 contour lines of the structured polygon 24. Alternatively, information of the plurality of contour lines can also be the positions and lengths of a part of the contour lines in the structured polygon 24, and a structured polygon can be uniquely determined based on the positions and lengths of this part of the contour lines. For example, a part of the contour lines can be a contour line formed by the vertex p₇ and the vertex p₈ (a first contour line), a contour line formed by the vertex p₇ and the vertex p₃ (a second contour line), and a contour line formed by the vertex p₇ and the vertex p₆ (a third contour line), or a part of the contour lines can be the contour line formed by the vertex p₇ and the vertex p₈ (the first contour line), the contour line formed by the vertex p₇ and the vertex p₃ (the second contour line), the contour line formed by the vertex p₇ and the vertex p₆ (the third contour line) and a contour line formed by the vertex p₄ and the vertex p₈ (a fourth contour line). Which contour lines are specifically used to uniquely determine a structured polygon can be determined according to actual conditions, which is not specifically limited in the embodiments of the present disclosure.

Through the above steps, the vertex information (structured polygons generally include a plurality of vertices), the plane information (structured polygons generally include a plurality of surfaces), and the contour line information (structured polygons generally include a plurality of contour lines) are basic information for constructing a structured polygon. Based on such basic information, a structured polygon can be uniquely constructed, and the shape of the object under detection can be more accurately represented.

In a possible implementation, referring to FIG. 4, based on the two-dimensional image, determining the attribute information of the structured polygon corresponding to each of the one or more objects under detection includes the following steps S401-S403.

In S401, obtaining one or more object areas in the two-dimensional image by performing object detection on the two-dimensional image. Each of the one or more object areas involves one of the objects under detection.

In S402, for each of the one or more objects under detection, based on the object area corresponding to the object under detection and second preset size information, cutting a target image corresponding to the object under detection from the two-dimensional image. The second preset size information represents a size greater than or equal to a size of the object area of each of the one or more objects under detection.

In S403, obtaining the attribute information of the structured polygon corresponding to the object under detection by performing feature extraction on the target image corresponding to the object under detection.

In the embodiments of the present disclosure, object detection can be performed on the two-dimensional image through a trained first neural network model, to obtain a first detection box (indicating an object area) corresponding to each of objects under detection in the two-dimensional image. Here, each object area involves an object under detection.

In specific implementation, when performing feature extraction on the target image corresponding to each of objects under detection, the size of the target image corresponding to each of the objects under detection can be made consistent, so a second preset size can be set. In this way, by cutting the target image corresponding to each of the objects under detection from the two-dimensional image, the size of the target image corresponding to each of the objects under detection can be the same as the second preset size.

Exemplarily, the second preset size information can be determined based on historical experience. For example, based on a size of each object area in the historical experience, the largest size from the sizes corresponding to a plurality of object areas can be selected as the second preset size. In this way, the second preset size can be set to be greater than or equal to the size of each of the object areas, thereby making inputs of a model for performing feature extraction on the target image consistent, and ensuring that features of the object under detection contained in each object area are complete. In other words, it can be avoided that when the second preset size is smaller than the size of any object area, some of the features of the object under detection contained in the object area are omitted. For example, if the second preset size is smaller than the size of the object area of an object A under detection, a target image ImgA corresponding to the object A under detection is obtained based on the second preset size, then features of the object A under detection contained in the target image ImgA are not complete, which in turn makes the obtained attribute information of the structured polygon corresponding to the object A under detection inaccurate. Exemplarily, by taking a center point of each object area as the center point of respective target image and taking the second preset size as the size of the respective target image, the respective target image corresponding to each object under detection can be cut from the two-dimensional image.

In specific implementation, the feature extraction on the target image corresponding to each object under detection can be performed through a trained structure detection model to obtain the attribute information of the structured polygon corresponding to each object under detection. Here, the structure detection model can be obtained based on training a basic deep learning model.

For example, when the structure detection model includes a vertex determination model, the vertex determination model is obtained by training a basic deep learning model, and the target image corresponding to each object under detection is input to the trained vertex determination model to obtain coordinates of all vertices or part of the vertices corresponding to the object under detection. Alternatively, when the structure detection model includes a plane determination model, the plane determination model is obtained by training a basic deep learning model, and the target image corresponding to each object under detection is input to the trained plane determination model to obtain information of all planes or information of part of the planes corresponding to the object under detection. The plane information includes at least one of a plane position, a plane shape, or a plane size. Alternatively, when the structure detection model includes a contour line determination model, the contour line determination model is obtained by training a basic deep learning model, and the target image corresponding to each object under detection is input into the trained contour line determination model to obtain information of all contour lines or part of the contour lines corresponding to the object under detection, and the contour line information includes the position and length of a contour line.

In the embodiments of the present disclosure, for each of the objects under detection, the target image corresponding to the object under detection is first cut from the two-dimensional image, and then feature extraction is performed on the target image corresponding to the object under detection, to obtain the attribute information of the structured polygon corresponding to the object under detection. Here, the target image corresponding to each of the objects under detection is processed into a uniform size, which can simplify the processing of the model used for performing feature extraction on the target image and improve the processing efficiency.

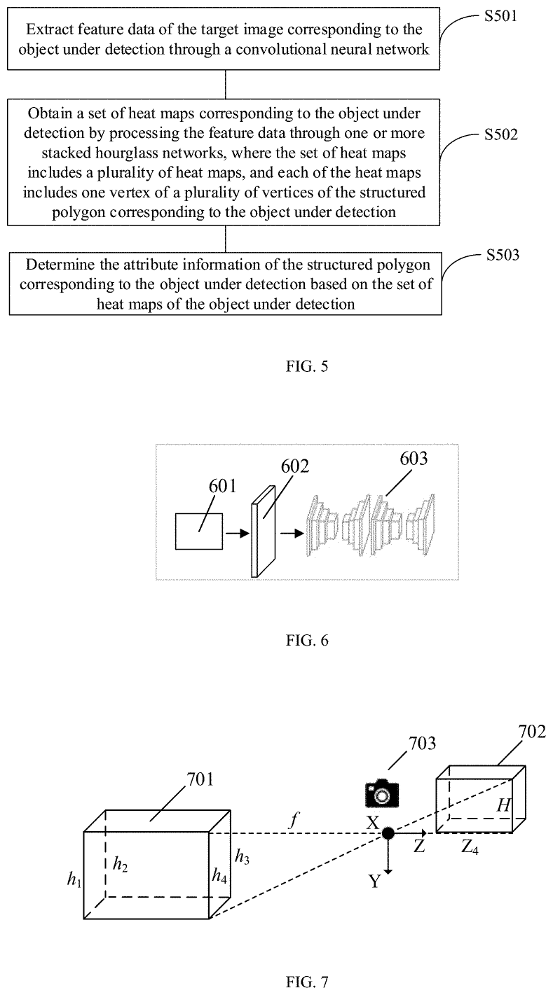

Exemplarily, referring to FIG. 5, when the attribute information includes the vertex information, according to the following steps S501 to S503, feature extraction can be performed on the target image corresponding to each object under detection to obtain the attribute information of the structured polygon corresponding to each object under detection.

In S501, extracting feature data of the target image corresponding to the object under detection through a convolutional neural network.

In S502, obtaining a set of heat maps corresponding to the object under detection by processing the feature data through one or more stacked hourglass networks. The set of heat maps includes a plurality of heat maps, and each of the heat maps includes one vertex of a plurality of vertices of the structured polygon corresponding to the object under detection.

In S503, determining the attribute information of the structured polygon corresponding to the object under detection based on the set of heat maps of the object under detection.

In the embodiments of the present disclosure, the target image corresponding to each object under detection can be processed through a trained feature extraction model to determine the attribute information of the structured polygon corresponding to each object under detection. The feature extraction model can include a convolutional neural network and at least one stacked hourglass network, and the number of the at least one stacked hourglass network can be determined according to actual needs. Specifically, referring to the structural schematic diagram of the feature extraction model shown in FIG. 6, which includes a target image 601, a convolutional neural network 602, and two stacked hourglass networks 603. For each object under detection, the target image 601 corresponding to the object under detection is input into the convolutional neural network 602 for feature extraction, and feature data corresponding to the target image 601 is determined; the feature data corresponding to the target image 601 is input into the two stacked hourglass networks 603 to obtain a set of heat maps corresponding to the object under detection. In this way, the attribute information of the structured polygon corresponding to the object under detection can be determined based on the set of heat maps corresponding to the object under detection.

Here, a set of heat maps includes a plurality of heat maps, and each feature point in each heat map corresponds to a probability value, and the probability value represents a probability that the feature point indicates a vertex. In this way, a feature point with the largest probability value can be selected from a heat map as one of the vertices of the structured polygon corresponding to the set of heat maps to which the heat map belongs. In addition, the position of the vertex corresponding to each of the heat maps is different, and the number of the plurality of heat maps included in a set of heat maps can be set according to actual needs.

Exemplarily, if the attribute information includes the coordinate information of eight vertices of a structured polygon, the set of heat maps can be set to include eight heat maps. The first heat map can include the vertex p₁ of the structured polygon in FIG. 2a, the second heat map can include the vertex p₂ of the structured polygon in FIG. 2a, . . . , and the eighth heat map can include the vertex p₈ of the structured polygon in FIG. 2a. If the attribute information includes the coordinate information of part of the vertices of the structured polygon, for example, a part of the vertices indicate p₃, p₄, p₅, p₆, p₇, p₈, the set of heat maps can be set to include six heat maps, and the first heat map can include the vertex p₃ of the structured polygon in FIG. 2a, the second heat map can include the vertex p₄ of the structured polygon in FIG. 2a, . . . , and the sixth heat map can include the vertex p₈ of the structured polygon in FIG. 2a.

In a possible implementation, based on the two-dimensional image, determining the attribute information of the structured polygon corresponding to the object under detection includes: performing feature extraction on the two-dimensional image to obtain information of a plurality of target elements in the two-dimensional image, the target elements include at least one of vertices, surfaces, or contour lines; clustering the target elements based on the information of the plurality of target elements to obtain at least one set of clustered target elements; and for each set of target elements, forming a structured polygon according to target elements in the set of target elements, and taking the information of the target elements in the set of target elements as the attribute information of the structured polygon.

In the embodiments of the present disclosure, it is also possible to perform feature extraction on the two-dimensional image to determine the attribute information of the structured polygon corresponding to each object under detection in the two-dimensional image. For example, when a target element indicates a vertex, if the two-dimensional image includes two objects under detection, that is, a first object under detection and a second object under detection, then feature extraction is performed on the two-dimensional image to obtain information of a plurality of vertices included in the two-dimensional image. Based on the information of the plurality of vertices, the vertices are clustered (that is, based on the information of the vertices, the object under detection corresponding to the vertices is determined, and the vertices belonging to the same object under detection are clustered together) to obtain clustered sets of target elements. The first object under detection corresponds to a first set of target elements, and the second object under detection corresponds to a second set of target elements. A structured polygon corresponding to the first object under detection can be formed according to target elements in the first set of target elements, and the information of the target elements in the first set of target elements is taken as attribute information of the structured polygon corresponding to the first object under detection. A structured polygon corresponding to the second object under detection can be formed according to target elements in the second set of target elements, and the information of the target elements in the second set of target elements is taken as attribute information of the structured polygon corresponding to the second object under detection.

In the embodiments of the present disclosure, a set of target elements for each category is obtained by clustering each of the target elements in the two-dimensional image, and elements in each set of target elements obtained in this way represent elements in one object under detection. Then, based on each set of target elements, the structured polygon of the object under detection corresponding to the set of target elements can be obtained.

Regarding S103, considering that no depth information is involved in the two-dimensional image, in order to determine the depth information of the two-dimensional image, in the embodiments of the present disclosure, height information of the object under detection and height information of at least one side of the structured polygon corresponding to the object under detection can be used to calculate the depth information of the vertices in the structured polygon.

In a possible implementation, for each object under detection, calculating the depth information of the vertices in the structured polygon based on the height information of the object under detection and the height information of vertical sides of the structured polygon corresponding to the object under detection, includes: for each object under detection, determining a ratio between a height of the object under detection and a height of each vertical side in the structured polygon; and for each vertical side, determining a product of the ratio corresponding to the vertical side with a focal length of a camera device which captured the two-dimensional image as depth information of a vertex corresponding to the vertical side.

Referring to FIG. 7, a structured polygon 701 corresponding to an object under detection, a three-dimensional bounding box 702 of the object under detection in a three-dimensional space, and a camera device 703 are shown in the figure. It can be seen from FIG. 7 that the height H of the object under detection, the height hⱼ of at least one vertical side in the structured polygon corresponding to the object under detection, and the depth information Zⱼ of the vertex corresponding to the at least one vertical side have the following relationship:

$${Z}_{j} = f \cdot \frac{H}{{h}_{j}} \qquad ( 1 )$$

where f is the focal length of a camera device; f={1,2,3,4}, which is the serial number of any one of four vertical sides of the structured polygon (that is, h₁ corresponds to the height of the first vertical side, h₂ corresponds to the height of the second vertical side, or the like).

In specific implementation, the value off can be determined according to the camera device. If j indicates 4, by determining the value of h₄ and the height H of the corresponding object under detection, the depth information of any point on the vertical side corresponding to h₄ can be obtained, that is, the depth information of the vertices at both ends of the fourth vertical side can be obtained. Further, the depth information of each vertex on the structured polygon can be obtained.

Exemplarily, the value of hⱼ can be determined on the structured polygon; or, when the attribute information indicates contour line information, after the contour line information is obtained, the value of hⱼ can be determined based on the obtained contour line information; or, a height information detection model can also be provided, and based on the height information detection model, the value of hⱼ in the structured polygon can be determined. The height information detection model can be obtained based on training a neural network model.

In a possible implementation, determining the height of the object under detection includes: determining the height of each object under detection in the two-dimensional image based on the two-dimensional image and a pre-trained neural network for height detection; or, collecting in advance real height values of the object under detection in a plurality of different attitudes, and taking an average value of the plurality of real height values collected as the height of the object under detection; or obtaining a regression variable of the object under detection based on the two-dimensional image and a pre-trained neural network for object detection, and determining the height of the object under detection based on the regression variable and an average height of the object under detection in a plurality of different attitudes obtained in advance. The regression variable represents the degree of deviation between the height of the object under detection and the average height.

Exemplarily, when the object under detection indicates a vehicle, real height values of a plurality of vehicles of different models can be collected in advance, the plurality of collected real height values are averaged, and the obtained average value is used as the height of the object under detection.

Exemplarily, the two-dimensional image can also be input into a trained neural network for height detection, to obtain the height of each object under detection involved in the two-dimensional image. Alternatively, it is also possible to input the cut target image corresponding to each object under detection into a trained neural network for height detection to obtain the height of the object under detection corresponding to the target image.

Exemplarily, the two-dimensional image can also be input into a trained neural network for object detection to obtain a regression variable for each object under detection, and based on the regression variable and the average height of objects under detection in a plurality of different attitudes obtained in advance, the height of each object under detection is determined. Alternatively, the cut target image corresponding to each object under detection can be input into the trained neural network for object detection to obtain the regression variable of each object under detection, and based on the regression variable and the average height of objects under detection in a plurality of different attitudes obtained in advance, the height of each object under detection is determined. Here, the following relationship exists between the regression variable t_{H}, the average height A_{H}, and the height H:

H=A_{H},e^{t}^{_{H}}; (2)

Through the above formula (2), the height H corresponding to each object under detection can be obtained.

Regarding S104, in the embodiments of the present disclosure, the depth information of the vertices in the structured polygon obtained by calculation and the two-dimensional coordinate information of the vertices of the structured polygon in the two-dimensional image can be used to determine three-dimensional coordinate information of the three-dimensional bounding box corresponding to the object under detection. Based on the three-dimensional coordinate information of the three-dimensional bounding box corresponding to the object under detection, three-dimensional spatial information of the object under detection is determined.

Specifically, a unique projection point in the two-dimensional image can be obtained for each point on the object under detection. Therefore, there is the following relationship between each point on the object under detection and a corresponding feature point in the two-dimensional image:

K·[Xᵢ,Yᵢ,Zᵢ]^{T}=[uᵢ,vᵢ,1]^{T}·Zᵢ; (3)

K indicates an internal parameter of a camera device, i can represent any point on the object under detection, [Xᵢ, Yᵢ, Zᵢ] indicates three-dimensional coordinate information corresponding to any point i on the object under detection, (uᵢ, vᵢ) indicates two-dimensional coordinate information of a projection point projected on the two-dimensional image by any point i in the object under detection. Zᵢ indicates corresponding depth information solved from the equation. Here, the three-dimensional coordinate information is coordinate information in an established world coordinate system, and the two-dimensional coordinate information is coordinate information in an established imaging planar coordinate system. The origin position of the world coordinate system and the imaging planar coordinate system are the same.

Exemplarily, i can also represent the vertices on the three-dimensional bounding box corresponding to the object under detection, then i=1, 2, . . . , 8, [Xᵢ, Yᵢ, Zᵢ] indicates the three-dimensional coordinate information of the vertices on the three-dimensional bounding box, (uᵢ, vᵢ) indicates two-dimensional coordinate information of the vertices of the structured polygon which correspond to the vertices of the three-dimensional bounding box and are projected on the two-dimensional image. Zᵢ indicates corresponding depth information solved from the equation.

Here the three-dimensional spatial information of the object under detection is related to the three-dimensional bounding box corresponding to the object under detection. For example, the three-dimensional spatial information of the object under detection can be determined according to the three-dimensional bounding box corresponding to the object under detection. In specific implementation, the three-dimensional spatial information can include at least one of spatial position information, orientation information, or size information.

In the embodiments of the present disclosure, the spatial position information can be the coordinate information of a center point of the three-dimensional bounding box corresponding to the object under detection, for example, coordinate information of an intersection point between a line segment P₁P₇ (a connection line between the vertex P₁ and the vertex P₇) and a line segment P₂P₈ (a connection line between the vertex P₂ and the vertex P₈) in FIG. 2b. It can also be the coordinate information of the center point of any surface in the three-dimensional bounding box corresponding to the object under detection, for example, coordinate information of a center point of a plane formed by the vertex P₂, the vertex P₃, the vertex P₆ and the vertex P₇ in FIG. 2b, that is, coordinate information of an intersection point between a line segment P₂P₇ and a line segment P₃P₆.

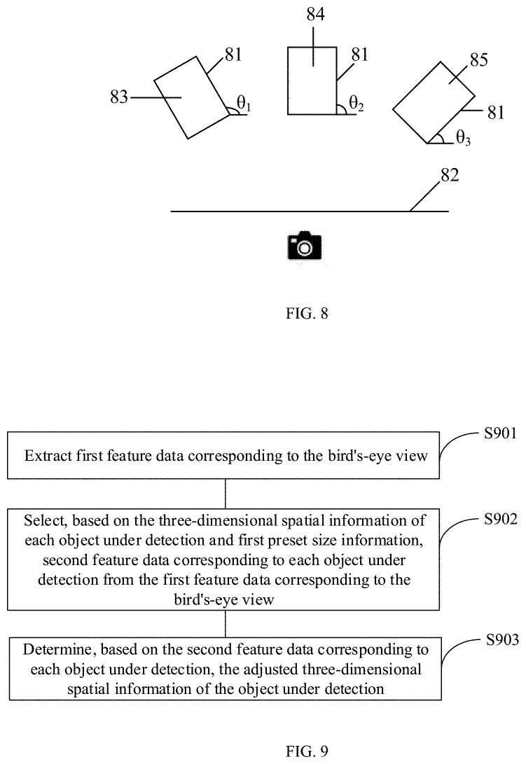

In the embodiments of the present disclosure, the orientation information can be a value of an included angle between a target plane set on the three-dimensional bounding box and a preset reference plane. FIG. 8 shows a top view of an image under detection. FIG. 8 includes a target plane 81 set on the three-dimensional bounding box corresponding to the object under detection and a preset reference plane 82 (the reference plane can be the plane where the camera device is located), and it can be seen that the orientation information of the object 83 under detection can be an included angle θ₁, the orientation information of the object 84 under detection can be an included angle θ₂, and the orientation information of the object 85 under detection can be an included angle θ₃.

In the embodiments of the present disclosure, the size information can be any one or more of a length, width, and height of the three-dimensional bounding box corresponding to the object under detection. For example, the length of the three-dimensional bounding box can be the value of a line segment P₃P₇, the width of the three-dimensional bounding box can be the value of a line segment P₃P₂, and the height of the three-dimensional bounding box can be the value of a line segment P₃P₄. Exemplarily, after the three-dimensional coordinate information of the three-dimensional bounding box corresponding to the object under detection is determined, an average value of four long sides can be calculated, and the resulted average length is determined as the length of the three-dimensional bounding box. For example, an average length of the line segments P₃P₇, P₄P₈, P₁P₅, and P₂P₆ can be calculated, and the resulted average length can be determined as the length of the three-dimensional bounding box. In the same way, the width and height of the three-dimensional bounding box corresponding to the object under detection can be obtained. Alternatively, since there are cases where some sides in the three-dimensional bounding box are occluded, in order to improve the accuracy of the calculated size information, the length of the three-dimensional bounding box can be determined by a selected part of the long sides, the width of the three-dimensional bounding box can be determined by a selected part of wide sides, and the height of the three-dimensional bounding box can be determined by a selected part of vertical sides, so as to determine the size information of the three-dimensional bounding box. Exemplarily, the selected part of the long sides can be a long side that is not blocked, the selected part of the wide sides can be a wide side that is not blocked, and the selected part of the vertical sides can be a vertical side that is not blocked. For example, an average length of the line segments P₃P₇, P₄P₈, and P₁P₅ is calculated, and the resulted average length is determined as the length of the three-dimensional bounding box. In the same way, the width and height of the three-dimensional bounding box corresponding to the object under detection can be obtained.

In a possible implementation, after determining the three-dimensional spatial information of the object under detection, the method further includes: generating a bird's-eye view corresponding to the two-dimensional image based on the two-dimensional image and a depth map corresponding to the two-dimensional image; and adjusting the three-dimensional spatial information of each object under detection based on the bird's-eye view to obtain adjusted three-dimensional spatial information of the object under detection.

In the embodiments of the present disclosure, the corresponding depth map can be determined based on the two-dimensional image. For example, the two-dimensional image can be input into a trained deep ordinal regression network (DORN) to obtain the corresponding depth map of the two-dimensional image. Exemplarily, the depth map corresponding to the two-dimensional image can also be determined based on a binocular ranging method. Alternatively, the depth map corresponding to the two-dimensional image can also be determined based on a depth camera. Specifically, the method for determining the depth map corresponding to the two-dimensional image can be determined according to the actual situation, as long as the size of the obtained depth map is consistent with the size of the two-dimensional image.

In the embodiments of the present disclosure, a bird's-eye view corresponding to the two-dimensional image is generated based on the two-dimensional image and the depth map corresponding to the two-dimensional image, and the bird's-eye view includes depth value. When the three-dimensional spatial information of the object under detection is adjusted based on the bird's-eye view, the adjusted three-dimensional spatial information can be more consistent with the corresponding object under detection.

In a possible implementation, generating the bird's-eye view corresponding to the two-dimensional image based on the two-dimensional image and the depth map corresponding to the two-dimensional image includes: based on the two-dimensional image and the depth map corresponding to the two-dimensional image, obtaining point cloud data corresponding to the two-dimensional image, where the point cloud data includes three-dimensional coordinate values of a plurality of space points in a real space corresponding to the two-dimensional image; based on the three-dimensional coordinate values of each space point in the point cloud data, generating the bird's-eye view corresponding to the two-dimensional image.

In the embodiments of the present disclosure, for the feature point i in the two-dimensional image, based on the two-dimensional coordinate information (uᵢ, vᵢ) of the feature point and the corresponding depth value Zᵢ on the depth map, three-dimensional coordinate value (Xᵢ, Yᵢ, Zᵢ) of the space point in the real space corresponding to the feature point i can be obtained through the formula (3), and then the three-dimensional coordinate value of each space point in the real space corresponding to the two-dimensional image can be obtained. Further, based on the three-dimensional coordinate value of each space point in the point cloud data, the bird's-eye view corresponding to the two-dimensional image is generated.

In a possible implementation, generating the bird's-eye view corresponding to the two-dimensional image based on the three-dimensional coordinate values of each space point in the point cloud data includes: for each space point, determining a horizontal axis coordinate value of the space point as a horizontal axis coordinate value of a feature point corresponding to the space point in the bird's-eye view, determining a longitudinal axis coordinate value of the space point as a pixel channel value of the feature point corresponding to the space point in the bird's-eye view, and determining a vertical axis coordinate value of the space point as a longitudinal axis coordinate value of the feature point corresponding to the space point in the bird's-eye view.

In the embodiments of the present disclosure, for a space point A (X_{A}, Y_{A}, Z_{A}), a horizontal axis coordinate value X_{A} of the space point is determined as a horizontal axis coordinate value of a feature point corresponding to the space point A in the bird's-eye view, and a vertical axis coordinate value Y_{A} of the space point is determined as a longitudinal axis coordinate value of the feature point corresponding to the space point A in the bird's-eye view, and a longitudinal axis coordinate value Z_{A} of the space point is determined as a pixel channel value of the feature point corresponding to the space point A in the bird's-eye view.

A feature point in the bird's-eye view may correspond to a plurality of space points, and the plurality of space points are space points at the same horizontal position and with different heights. In other words, the X_{A} and Y_{A} of the plurality of space points are the same, but the Z_{A} are different. In this case, the largest value can be selected from the vertical axis coordinate values Z_{A} corresponding to the plurality of space points as the pixel channel value corresponding to the feature point.

In a possible implementation, as shown in FIG. 9, for each object under detection, adjusting the three-dimensional spatial information of the object under detection based on the bird's-eye view to obtain the adjusted three-dimensional spatial information of the object under detection includes: S901, extracting first feature data corresponding to the bird's-eye view; S902, based on the three-dimensional spatial information of each object under detection and first preset size information, selecting second feature data corresponding to each object under detection from the first feature data corresponding to the bird's-eye view; S903, based on the second feature data corresponding to each object under detection, determining the adjusted three-dimensional spatial information of the object under detection.

In the embodiments of the present disclosure, the first feature data corresponding to the bird's-eye view can be extracted based on a convolutional neural network. Exemplarily, for each object under detection, a three-dimensional bounding box corresponding to the object under detection can be determined based on the three-dimensional spatial information of the object under detection. By taking a center point of each three-dimensional bounding box as the center of respective selection box and taking the first preset size as the size of respective selection box, the respective selection box corresponding to each object under detection is determined. Based on the determined selection box, the second feature data corresponding to each object under detection is selected from the first feature data corresponding to the bird's-eye view. For example, if the first preset size is 6 cm in length and 4 cm in width, the center point of the three-dimensional bounding box is used as the center to determine a selection box with a length of 6 cm and a width of 4 cm. Based on the determined target selection box, from the first feature data corresponding to the bird's-eye view, the second feature data corresponding to each object under detection is selected.

In the embodiments of the present disclosure, the second feature data corresponding to each object under detection can also be input to at least one convolution layer for convolution processing to obtain intermediate feature data corresponding to the second feature data. The obtained intermediate feature data is input to a first fully connected layer for processing, and a residual value of the three-dimensional spatial information of the object under detection is obtained. Based on the residual value of the three-dimensional spatial information, the adjusted three-dimensional spatial information of the object under detection is determined. Alternatively, the obtained intermediate feature data can also be input to a second fully connected layer for processing, and the adjusted three-dimensional spatial information of the object under detection can be directly obtained.

In the embodiments of the present disclosure, for each object under detection, the second feature data corresponding to the object under detection is selected from the first feature data corresponding to the bird's-eye view, and the adjusted three-dimensional spatial information of the object under detection is determined based on the second feature data corresponding to the object under detection. In this way, the data processing volume of the model used to determine the adjusted three-dimensional spatial information of the object under detection is small, and the processing efficiency can be improved.

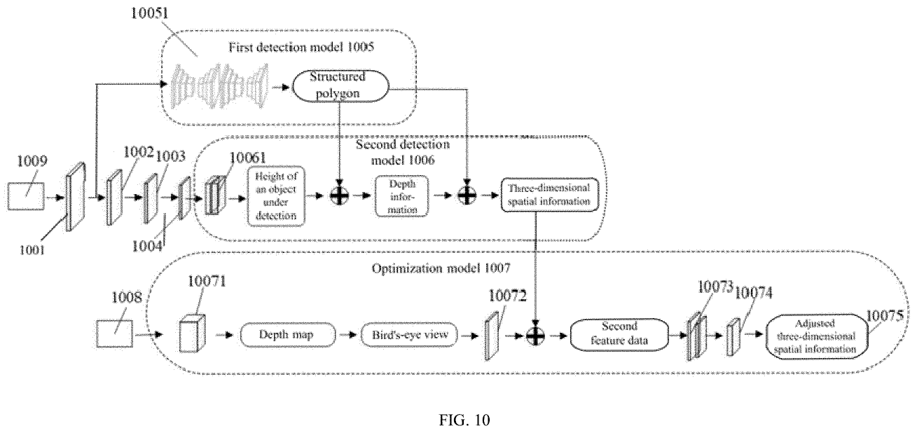

Exemplarily, an image detection model can be set, and an acquired two-dimensional image can be input into a trained image detection model for processing, so as to obtain adjusted three-dimensional spatial information of each object under detection included in the two-dimensional image. Referring to a schematic diagram of the structure of an image detection model in a detection method shown in FIG. 10, the image detection model includes a first convolution layer 1001, a second convolution layer 1002, a third convolution layer 1003, a fourth convolution layer 1004, a first detection model 1005, a second detection model 1006, and an optimization model 1007. The first detection model 1005 includes two stacked hourglass networks 10051, the second detection model 1006 includes at least one first fully connected layer 10061, and the optimization model 1007 includes a deep ordinal regression network 10071, a fifth convolution layer 10072, and a six convolution layer 10073, a seventh convolution layer 10074, and a second fully connected layer 10075.

Specifically, the acquired two-dimensional image 1008 is input into a cutting model for processing, and a target image 1009 corresponding to at least one object under detection included in the two-dimensional image is obtained. The cutting model is used to perform detection on the two-dimensional image to obtain a rectangular detection box corresponding to at least one object under detection included in the two-dimensional image. Then, based on the rectangular detection box corresponding to each object under detection and the corresponding second preset size information, a target image corresponding to each object under detection is selected from the two-dimensional image.

After the target image is obtained, each target image 1009 is input to the first convolution layer 1001 for convolution processing to obtain first convolution feature data corresponding to each target image. Then, the first convolution feature data corresponding to each target image is input into the first detection model 1005. Two hourglass networks 10051 stacked in the first detection model 1005 process the first convolution feature data corresponding to each target image to obtain a structured polygon corresponding to each target image. Then, the obtained structured polygon corresponding to each target image is input into the second detection model 1006.

At the same time, the first convolution feature data corresponding to each target image is sequentially input into the second convolution layer 1002, the third convolution layer 1003, and the fourth convolution layer 1004 for convolution processing to obtain second convolution feature data corresponding to each target image. The second convolution feature data is input into the second detection model 1006, and at least one first fully connected layer 10061 in the second detection model 1006 processes the second convolution feature data to obtain height information of each object under detection. For each object under detection, based on the height information of the object under detection and the received structured polygon, depth information of vertices in the object under detection is determined, and then three-dimensional spatial information of the object under detection is obtained, and the obtained three-dimensional spatial information is input to the optimization model.

At the same time, the two-dimensional image is input into the optimization model 1007, and the depth ordinal regression network 10071 in the optimization model 1007 processes the two-dimensional image to obtain a depth map corresponding to the two-dimensional image. Based on the two-dimensional image and the depth map corresponding to the two-dimensional image, a bird's-eye view corresponding to the two-dimensional image is obtained and input to the fifth convolution layer 10072 for convolution processing to obtain first feature data corresponding to the bird's-eye view. Then, based on the obtained three-dimensional spatial information and the first preset size information, second feature data corresponding to each object under detection is selected from the first feature data corresponding to the bird's-eye view. Then, the second feature data is sequentially input into the sixth convolution layer 10073 and the seventh convolution layer 10074 for convolution processing to obtain the third convolution feature data. Finally, the third convolution feature data is input to the second fully connected layer 10075 for processing, to obtain adjusted three-dimensional spatial information of each object under detection.

According to a detection method provided by the embodiments of the present disclosure, since the constructed structured polygon is the projection of the three-dimensional bounding box corresponding to the object under detection in the two-dimensional image, the constructed structured polygon can better characterize three-dimensional features of the object under detection. This makes the depth information predicted based on the structured polygon has a higher accuracy than the depth information directly predicted based on features of the two-dimensional image, which in turn makes the three-dimensional spatial information of the object under detection obtained correspondingly more accurate, which improves the accuracy of 3D detection results.

Those skilled in the art can understand that in the above-mentioned method of the specific implementation, the description order of the steps does not mean a strict execution order nor constitutes any limitation on the implementation process. The specific execution order of the steps should be determined based on its function and possible inner logic.

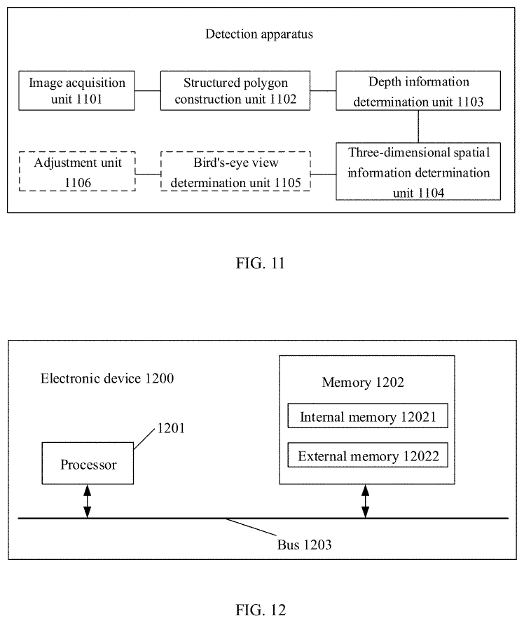

The embodiments of the present disclosure also provide a detection apparatus. As shown in FIG. 11, the schematic diagram of the architecture of the detection apparatus provided by the embodiments of the present disclosure includes an image acquisition unit 1101, a structured polygon construction unit 1102, a depth information determination unit 1103, and a three-dimensional spatial information determination unit 1104. Specifically, the image acquisition unit 1101 is configured to acquire a two-dimensional image. The structured polygon construction unit 1102 is configured to construct, for each of one or more objects under detection in the two-dimensional image, a structured polygon corresponding to the object under detection based on the acquired two-dimensional image, where for each of the one or more objects under detection, a structured polygon corresponding to the object under detection represents projection of a three-dimensional bounding box corresponding to the object under detection in the two-dimensional image. The depth information determination unit 1103 is configured to, for each of the one or more objects under detection, calculate depth information of vertices in the structured polygon based on height information of the object under detection and height information of vertical sides of the structured polygon corresponding to the object under detection. The three-dimensional spatial information determination unit 1104 is configured to determine three-dimensional spatial information of the object under detection based on the depth information of the vertices in the structured polygon and two-dimensional coordinate information of the vertices of the structured polygon in the two-dimensional image, where the three-dimensional spatial information of the object under detection is related to the three-dimensional bounding box corresponding to the object under detection.

In a possible implementation, the detection apparatus further includes: a bird's-eye view determination unit 1105 configured to generate a bird's-eye view corresponding to the two-dimensional image based on the two-dimensional image and a depth map corresponding to the two-dimensional image; and an adjustment unit 1106 configured to, for each object under detection, adjust the three-dimensional spatial information of each object under detection based on the bird's-eye view to obtain adjusted three-dimensional spatial information of the object under detection.

In a possible implementation, the bird's-eye view determination unit is configured to obtain point cloud data corresponding to the two-dimensional image based on the two-dimensional image and the depth map corresponding to the two-dimensional image, where the point cloud data includes three-dimensional coordinate values of a plurality of space points in a real space corresponding to the two-dimensional image; and generate the bird's-eye view corresponding to the two-dimensional image based on the three-dimensional coordinate values of each of the space points in the point cloud data.

In a possible implementation, the bird's-eye view determination unit is configured to, for each of the space points, determine a horizontal axis coordinate value of the space point as a horizontal axis coordinate value of a feature point corresponding to the space point in the bird's-eye view, determine a longitudinal axis coordinate value of the space point as a pixel channel value of the feature point corresponding to the space point in the bird's-eye view, and determine a vertical axis coordinate value of the space point as a longitudinal axis coordinate value of the feature point corresponding to the space point in the bird's-eye view.

In a possible implementation, the adjustment unit is configured to extract first feature data corresponding to the bird's-eye view; for each object under detection, select second feature data corresponding to the object under detection from the first feature data corresponding to the bird's-eye view based on the three-dimensional spatial information of the object under detection and first preset size information, and determine the adjusted three-dimensional spatial information of the object under detection based on the second feature data corresponding to the object under detection.

In a possible implementation, the structured polygon construction unit is configured to for each of the one or more objects under detection, determine attribute information of the structured polygon corresponding to the object under detection based on the two-dimensional image, where the attribute information includes at least one of: vertex information, surface information, or contour line information; and construct the structured polygon corresponding to the object under detection based on the attribute information of the structured polygon corresponding to the object under detection.

In a possible implementation, the structured polygon construction unit is configured to, perform object detection on the two-dimensional image to obtain one or more object areas in the two-dimensional image, where each of the one or more object areas contains one of the objects under detection; for each of the one or more objects under detection, based on the object area corresponding to the object under detection and second preset size information, cut a target image corresponding to the object under detection from the two-dimensional image, where the second preset size information represents a size greater than or equal to a size of the object area of each of the one or more objects under detection; and perform feature extraction on the target image corresponding to the object under detection, to obtain the attribute information of the structured polygon corresponding to the object under detection.

In a possible implementation, the structured polygon construction unit is configured to extract feature data of the target image through a convolutional neural network; process the feature data through at least one stacked hourglass network to obtain a set of heat maps of the object under detection corresponding to the target image, where the set of heat maps includes a plurality of heat maps, and each of the heat maps includes one vertex of a plurality of vertices of the structured polygon corresponding to the object under detection; and determine the attribute information of the structured polygon corresponding to the object under detection based on the set of heat maps corresponding to the object under detection.

In a possible implementation, the structured polygon construction unit is configured to perform feature extraction on the two-dimensional image to obtain information of a plurality of target elements in the two-dimensional image, the plurality of target elements include at least one of vertices, surfaces, or contour lines; cluster the target elements based on the information of the plurality of target elements to obtain at least one set of clustered target elements; and for each set of target elements, form a structured polygon according to target elements in the set of target elements, and take information of the target elements in the set of target elements as the attribute information of the structured polygon.

In a possible implementation, the depth information determination unit is configured to, for each object under detection, determine a ratio between a height of the object under detection and a height of each vertical side in the structured polygon; and determine a product of the ratio corresponding to each vertical side with a focal length of a camera device which captured the two-dimensional image as depth information of a vertex corresponding to the vertical side.

In a possible implementation, the depth information determination unit is configured to determine the height of each object under detection in the two-dimensional image based on the two-dimensional image and a pre-trained neural network for height detection; or, collect in advance real height values of the object under detection in a plurality of different attitudes, and take an average value of the plurality of real height values collected as the height of the object under detection; or obtain a regression variable of the object under detection based on the two-dimensional image and a pre-trained neural network for object detection, and determine the height of the object under detection based on the regression variable and an average height of the object under detection in a plurality of different attitudes obtained in advance. The regression variable represents a degree of deviation between the height of the object under detection and the average height.

In some embodiments, the functions or units contained in the apparatus provided in the embodiments of the present disclosure can be used to execute the methods described in the above method embodiments. For specific implementation, reference can be made to the description of the above method embodiments, which will not be elaborated herein for brevity.

The embodiments of the present disclosure also provide an electronic device. Referring to FIG. 12, which is a schematic structural diagram of an electronic device according to an embodiment of the present disclosure, the electronic device includes a processor 1201, a memory 1202, and a bus 1203. Here, the memory 1202 is used to store execution instructions, and includes an internal memory 12021 and an external memory 12022. The internal memory 12021 is also called internal storage, and is used to temporarily store calculation data in the processor 1201 and data exchanged with an external memory 12022 such as a hard disk. The processor 1201 exchanges data with the external memory 12022 through the internal memory 12021. When the electronic device 1200 is running, the processor 1201 and the memory 1202 communicate through the bus 1203, so that the processor 1201 executes the following instructions: acquiring a two-dimensional image; constructing at least one structured polygon respectively corresponding to at least one object under detection in the two-dimensional image based on the acquired two-dimensional image, wherein for each object under detection, a structured polygon corresponding to the object under detection represents a projection of a three-dimensional bounding box corresponding to the object under detection in the two-dimensional image; for each object under detection, calculating depth information of vertices in the structured polygon based on height information of the object under detection and height information of vertical sides of the structured polygon corresponding to the object under detection; and based on the calculated depth information of the vertices in the structured polygon and two-dimensional coordinate information of the vertices of the structured polygon in the two-dimensional image, determine three-dimensional spatial information of the object under detection, wherein the three-dimensional spatial information of the object under detection is related to the three-dimensional bounding box corresponding to the object under detection.

In addition, the embodiments of the present disclosure also provide a computer-readable storage medium with a computer program stored on the computer-readable storage medium, and the computer program executes the steps of the detection method described in the above method embodiments when the computer program is run by a processor.

The computer program product of the detection method provided by the embodiments of the present disclosure includes a computer-readable storage medium storing program code. Instructions included in the program code can be used to execute the steps of the detection method described in the above method embodiments. Reference can be made to the above method embodiments, which will not be repeated here.

Those skilled in the art can clearly understand that, for the convenience and conciseness of the description, the specific working process of the system and apparatus described above can refer to the corresponding process in the foregoing method embodiments, which will not be repeated here. In the several embodiments provided in the present disclosure, it should be understood that the disclosed system, apparatus, and method can be implemented in other ways. The apparatus embodiments described above are merely illustrative. For example, the division of the units is only a logical function division, and there can be other divisions in actual implementation. For example, a plurality of units or components can be combined or can be integrated into another system, or some features can be ignored or not implemented. In addition, the displayed or discussed mutual coupling or direct coupling or communication connection can be indirect coupling or communication connection through some communication interfaces, apparatuses or units, and can be in electrical, mechanical or other forms.

The units described as separate components can or cannot be physically separated, and the components displayed as units can or cannot be physical units, that is, they can be located in one place, or they can be distributed on a plurality of network units. Some or all of the units can be selected according to actual requirements to achieve the objectives of the solutions of the embodiments.

In addition, the functional units in the various embodiments of the present disclosure can be integrated into one processing unit, or each unit can exist alone physically, or two or more units can be integrated into one unit.

If the function is implemented in the form of a software functional unit and sold or used as an independent product, it can be stored in a non-volatile computer readable storage medium executable by a processor. Based on this understanding, the technical solution of the present disclosure essentially or with the part that contributes to the prior art or the part of the technical solution can be embodied in the form of a software product, and the computer software product is stored in a storage medium, including some instructions that are used to make a computer device (which can be a personal computer, a server, or a network device, or the like) to execute all or part of the steps of the methods described in the various embodiments of the present disclosure. The aforementioned storage media include: USB flash disk, mobile hard disk, Read-Only Memory (ROM), Random Access Memory (RAM), magnetic disk or optical disk and other media that can store program code.

The above are only specific implementations of the present disclosure, but the protection scope of the present disclosure is not limited thereto. Any person skilled in the art can easily think of changes or substitutions within the technical scope disclosed in the present disclosure, and they shall be covered within the protection scope of this disclosure. Therefore, the protection scope of the present disclosure should be subject to the protection scope of the claims.

1. A detection method comprising:
acquiring a two-dimensional image;
constructing, for each of one or more objects under detection in the two-dimensional image, a structured polygon corresponding to the object under detection based on the acquired two-dimensional image, wherein for each of the one or more objects under detection, a structured polygon corresponding to the object under detection represents projection of a three-dimensional bounding box corresponding to the object under detection in the two-dimensional image;
for each of the one or more objects under detection,
calculating depth information of vertices in the structured polygon based on height information of the object under detection and height information of vertical sides of the structured polygon corresponding to the object under detection; and
determining three-dimensional spatial information of the object under detection based on the depth information of the vertices in the structured polygon and two-dimensional coordinate information of the vertices of the structured polygon in the two-dimensional image, wherein the three-dimensional spatial information of the object under detection is related to the three-dimensional bounding box corresponding to the object under detection.

2. The detection method according to claim 1, wherein after determining the three-dimensional spatial information of the object under detection, the detection method further comprises:
generating a bird's-eye view corresponding to the two-dimensional image based on the two-dimensional image and a depth map corresponding to the two-dimensional image; and
obtaining adjusted three-dimensional spatial information of the object under detection by adjusting the three-dimensional spatial information of each of the one or more objects under detection based on the bird's-eye view.

3. The detection method according to claim 2, wherein generating the bird's-eye view corresponding to the two-dimensional image based on the two-dimensional image and the depth map corresponding to the two-dimensional image comprises:
obtaining point cloud data corresponding to the two-dimensional image based on the two-dimensional image and the depth map corresponding to the two-dimensional image, wherein the point cloud data comprises three-dimensional coordinate values of a plurality of space points in a real space corresponding to the two-dimensional image; and
generating the bird's-eye view corresponding to the two-dimensional image based on the three-dimensional coordinate values of each of the plurality of space points in the point cloud data.

4. The detection method according to claim 3, wherein generating the bird's-eye view corresponding to the two-dimensional image based on the three-dimensional coordinate values of each of the plurality of space points in the point cloud data comprises:
for each of the plurality of space points:
determining a horizontal axis coordinate value of the space point as a horizontal axis coordinate value of a feature point corresponding to the space point in the bird's-eye view;
determining a longitudinal axis coordinate value of the space point as a pixel channel value of the feature point corresponding to the space point in the bird's-eye view; and
determining a vertical axis coordinate value of the space point as a longitudinal axis coordinate value of the feature point corresponding to the space point in the bird's-eye view.

5. The detection method according to claim 2, wherein obtaining the adjusted three-dimensional spatial information of the object under detection by adjusting the three-dimensional spatial information of each of the one or more objects under detection based on the bird's-eye view comprises:
extracting first feature data corresponding to the bird's-eye view;
selecting second feature data corresponding to the object under detection from the first feature data corresponding to the bird's-eye view based on the three-dimensional spatial information of the object under detection and first preset size information; and
determining the adjusted three-dimensional spatial information of the object under detection based on the second feature data corresponding to the object under detection.

6. The detection method according to claim 1, wherein constructing, for each of the one or more objects under detection in the two-dimensional image, the structured polygon corresponding to the object under detection based on the acquired two-dimensional image comprises:
for each of the one or more objects under detection,
determining attribute information of the structured polygon corresponding to the object under detection based on the two-dimensional image, wherein the attribute information comprises at least one of: vertex information, surface information, or contour line information; and
constructing the structured polygon corresponding to the object under detection based on the attribute information of the structured polygon corresponding to the object under detection.

7. The detection method according to claim 6, wherein determining the attribute information of the structured polygon corresponding to each of the one or more objects under detection based on the two-dimensional image comprises:
obtaining one or more object areas in the two-dimensional image by performing object detection on the two-dimensional image, wherein each of the one or more object areas contains one of the objects under detection;
for each of the one or more objects under detection,
cutting a target image corresponding to the object under detection from the two-dimensional image based on the object area corresponding to the object under detection and second preset size information, wherein the second preset size information represents a size greater than or equal to a size of the object area of each of the one or more objects under detection; and
obtaining the attribute information of the structured polygon corresponding to the object under detection by performing feature extraction on the target image corresponding to the object under detection.

8. The detection method according to claim 7, wherein when the attribute information comprises the vertex information, the feature extraction on the target image corresponding to the object under detection to obtain the attribute information of the structured polygon corresponding to the object under detection is performed by steps of:
extracting feature data of the target image through a convolutional neural network;
obtaining a set of heat maps of the object under detection corresponding to the target image by processing the feature data through one or more stacked hourglass networks, wherein the set of heat maps comprises a plurality of heat maps, and each of the plurality of heat maps comprises one vertex of a plurality of vertices of the structured polygon corresponding to the object under detection; and
determining the attribute information of the structured polygon corresponding to the object under detection based on the set of heat maps of the object under detection.

9. The detection method according to claim 6, wherein determining the attribute information of the structured polygon corresponding to the object under detection based on the two-dimensional image comprises:
obtaining information of a plurality of target elements in the two-dimensional image by performing feature extraction on the two-dimensional image, wherein the plurality of target elements comprise at least one of vertices, surfaces, or contour lines;
obtaining one or more sets of clustered target elements by clustering the plurality of target elements based on the information of the plurality of target elements;
for each set of the one or more sets of clustered target elements:
forming a structured polygon according to target elements in the set of clustered target elements, and
taking information of the target elements in the set of clustered target elements as the attribute information of the structured polygon.

10. The detection method according to claim 1, wherein calculating the depth information of vertices in the structured polygon based on the height information of the object under detection and the height information of vertical sides of the structured polygon corresponding to the object under detection comprises:
determining a ratio between a height of the object under detection and a height of each vertical side in the structured polygon; and
determining a product of the ratio corresponding to each vertical side with a focal length of a camera device which captured the two-dimensional image as depth information of a vertex corresponding to the vertical side.

11. The detection method according to claim 1, wherein the height information of the object under detection is determined by:
determining a height of the object under detection based on the two-dimensional image and a pre-trained neural network for height detection; or
collecting, in advance, a plurality of real height values of the object under detection in a plurality of different attitudes; and taking an average value of the plurality of real height values collected as the height of the object under detection; or
obtaining a regression variable of the object under detection based on the two-dimensional image and a pre-trained neural network for object detection; and determining the height of the object under detection based on the regression variable and an average height of the object under detection in a plurality of different attitudes obtained in advance, wherein the regression variable represents a degree of deviation between the height of the object under detection and the average height.

12. An electronic device, comprising:
at least one processor; and
one or more non-transitory memories coupled to the at least one processor and storing programming instructions for execution by the at least one processor to:
acquire a two-dimensional image;
construct, for each of one or more objects under detection in the two-dimensional image, a structured polygon corresponding to the object under detection based on the acquired two-dimensional image, wherein for each of the one or more objects under detection, a structured polygon corresponding to the object under detection represents projection of a three-dimensional bounding box corresponding to the object under detection in the two-dimensional image;
for each of the one or more objects under detection,
calculate depth information of vertices in the structured polygon based on height information of the object under detection and height information of vertical sides of the structured polygon corresponding to the object under detection; and
determine three-dimensional spatial information of the object under detection based on the depth information of the vertices in the structured polygon and two-dimensional coordinate information of the vertices of the structured polygon in the two-dimensional image, wherein the three-dimensional spatial information of the object under detection is related to the three-dimensional bounding box corresponding to the object under detection.

13. A non-transitory computer-readable storage medium coupled to at least one processor and storing programming instructions for execution by the at least one processor to perform operations comprising:
acquiring a two-dimensional image;
constructing, for each of one or more objects under detection in the two-dimensional image, a structured polygon corresponding to the object under detection based on the acquired two-dimensional image, wherein for each of the one or more objects under detection, a structured polygon corresponding to the object under detection represents projection of a three-dimensional bounding box corresponding to the object under detection in the two-dimensional image;
for each of the one or more objects under detection,
calculating depth information of vertices in the structured polygon based on height information of the object under detection and height information of vertical sides of the structured polygon corresponding to the object under detection; and
determining three-dimensional spatial information of the object under detection based on the depth information of the vertices in the structured polygon and two-dimensional coordinate information of the vertices of the structured polygon in the two-dimensional image, wherein the three-dimensional spatial information of the object under detection is related to the three-dimensional bounding box corresponding to the object under detection.
